(19) United States
(12) Patent Application Publication
(10) Pub. No.: US 2012/0005482 A1
(43) Pub. Date: Jan. 5, 2012

(54) SYSTEMS AND METHODS FOR SECURELY REQUESTING AND TRANSMITTING EDUCATIONAL RECORDS VIA THE INTERNET

(76) Inventor: Douglas R. Falk, Sterling, VA (US)

(21) Appl. No.: 13/207,915

(22) Filed: Aug. 11, 2011

(51) Int. Cl. H04L 9/32; H04L 9/00

(52) U.S. Cl. 713/176; 726/26; 713/150

(57) ABSTRACT

Systems and methods for securely ordering and transmitting educational records via the Internet are disclosed. A requestor orders educational records via a clearinghouse web site. An application services module receives the order and forwards it to a school over the Internet via a secure connector module. The secure connector module provides authentication, encryption, and validation services, and interfaces with an SIS operations module. The SIS operations module retrieves the requested records from the school's student information system (“SIS”). The educational records are transmitted back to the clearinghouse via the secure connector module. The requestor can then download the records from the clearinghouse via a secure web site.

### FIELD OF THE INVENTION

This application relates generally to secure electronic communications and, more particularly, to systems and methods for securely requesting and transmitting educational records via the Internet.

### BACKGROUND

Individuals often ask educational institutions to provide copies of their records. For example, a student applying to graduate school might ask for his transcript to be sent to another university. Or, a recent graduate might request that her transcript be sent to a prospective employer.

Historically, individuals requested educational records by submitting written requests through the mail or by facsimile. With the proliferation of the Internet over the past decade, individuals have become accustomed to the convenience and speed of online ordering. However, providing educational records electronically via the Internet is difficult because providers of online ordering applications do not have a secure interface to school information systems that provides data security and complies with privacy laws.

Thus, there is a need in the, art for a system and method for providing a secure interface between online ordering applications and educational institution student information systems for quick and efficient access to educational records via the Internet while still ensuring confidentiality and compliance with applicable privacy laws.

### BRIEF DESCRIPTION OF THE DRAWINGS

FIG. 1 is a block diagram of a networked computer system for securely providing educational records via the Internet.

FIG. 2 is a flow chart illustrating a method for securely providing educational records via the Internet.

### DETAILED DESCRIPTION OF THE DISCLOSED EMBODIMENTS

In the following detailed description, reference is made to the accompanying drawings, which form a part hereof and show by way of illustration specific embodiments of the present invention. These embodiments are described in sufficient detail to enable those skilled in the art to practice them, though it is understood that these are merely example embodiments and that other embodiments are possible. Moreover, as one of ordinary skill in the art would also recognize, the sequence of steps is not limited to that set forth herein and may be changed or reordered, with the exception of steps necessarily occurring in a certain order.

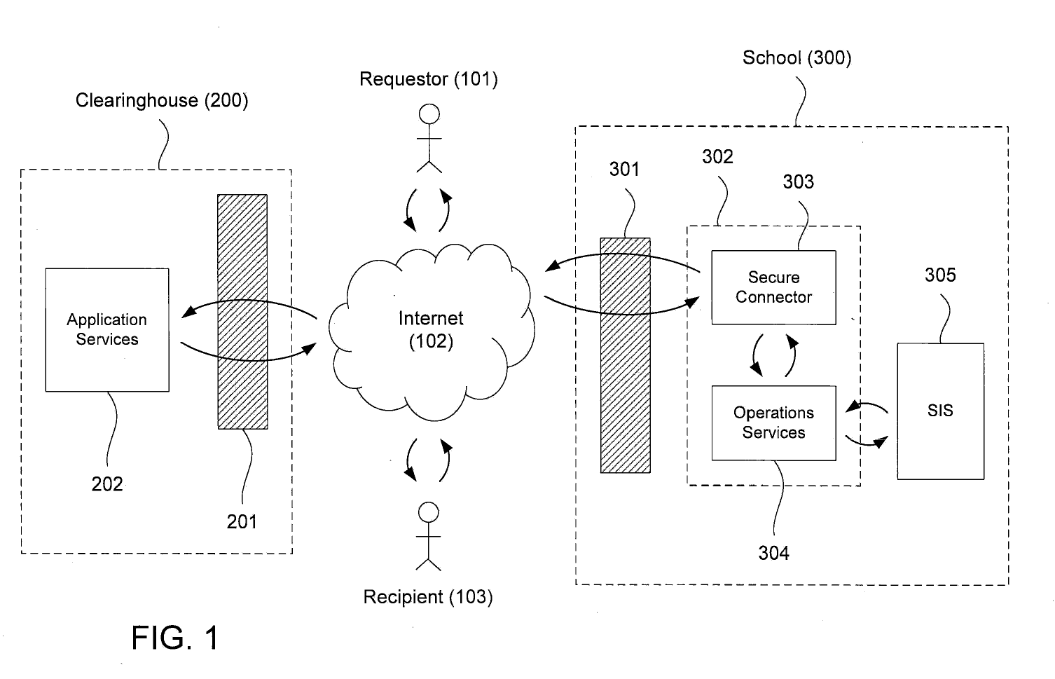

FIG. 1 is a block diagram of a networked computer system for securely providing educational records via the Internet in accordance with a disclosed embodiment. The system comprises a Clearinghouse 200, which operates a server hosting Application Services 202, and a School 300, which operates one or more servers hosting Secure Connector 303, Operations Services 304, and Student Information System (“SIS”) 305. Application Services 202 and Secure Connector 303 communicate with each other via a computer network, illustrated as Internet 102. A Requestor 101 and a Recipient 103 also communicate via Internet 102.

The Requestor 101 can be any individual or entity that requests educational records (e.g., a transcript) be sent to a Recipient 103. Likewise, Requestor 103 could be an individual or entity. For example, Requestor 101 might be an undergraduate student requesting that his transcript be sent to a prospective graduate school. Or, Requestor 101 might be former or current student requesting a transcript be sent to a prospective employer. Alternatively, Requestor 101 can request that the education records be sent to himself, in which case Requestor 101 and Recipient 103 are the same person.

Clearinghouse 200 is an intermediary that receives orders for educational records from Requestor 101. Clearinghouse 200 operates a server hosting Application Services 202, which can comprise, for example, web server software configured to securely receive orders from Requestor 101 via Internet 102. Application Services 202 also provides Requestor 101 with updates on the status of orders (e.g., via a status web page or e-mail message) and, ultimately, provides Recipient 103 with the requested educational records (e.g., via a secure web site). Firewall 201 provides security for Application Services 202 by, for example, filtering out unwanted traffic (e.g., would-be hackers or other unauthorized or malicious users) from Internet 102. Firewall 201 might also consist of multiple firewalls configured to provide a Data Management Zone (“DMZ”) or other security services, as known and practiced in the art. In alternative embodiments, Requestor 101 can submit an order to Clearinghouse 200 by telephone, facsimile, or even postal mail, though online ordering via Internet 102 is preferred for its low overhead.

School 300 can be any educational institution (e.g., a high school, college, university, or trade school). School 300 operates one or more servers hosting Integration Services 302 configured to receive orders from Clearinghouse 200 via Internet 102. Integration Services 302 comprises a Secure Connector 303 and Operations Services 304, which can be on the same or different servers. School 300 also operates a Student Information System (“SIS”) 305 that comprises a database of educational records (e.g., student enrollment, degree, and grade information such as commonly appears on transcripts). Preferably SIS 305 is hosted on a different physical or virtual server than Integration Services 302 for improved security. Firewall 301 provides security for SIS Integration Services 302 and SIS 305 similar to Firewall 201 described above.

Secure Connector 303 provides a communications interface between Application Services 202 at Clearinghouse 200 and Operations Services 304 at School 300. Secure Connector 303 allows for secure and authenticated communication between the Clearinghouse 200 and the School 300. Secure communication can be provided, for example, by Secure Socket Layer (“SSL”) or other encryption techniques known in the art. Authentication can also be provided using known techniques, such as through the use of digital certificates and digital signatures. For example, in one embodiment, Clearinghouse 200 and School 300 each have a digital certificate signed by a trusted third party. Communications from Clearinghouse 200 to School 300 (e.g., orders for educational records) can be digitally signed with that certificate and verified by School 300 upon receipt to ensure that the communication originated from Clearinghouse 200 and was not altered en route. Likewise, communications from School 300 (e.g., order status updates and transcripts) can be digitally signed by the School 300 and verified upon receipt by Clearinghouse 200.

Secure Connector 303 also verifies the format of communications received from Clearinghouse 200 before passing them on to Operations Services 304 for processing. This way, Secure Connector 303 can filter out or repair malformed messages that might otherwise cause Operations Services 304 to crash or experience some other error. Secure Connector 303 can also reformat communications (e.g., from one XML schema to another) as necessary to interface with Operations Services 304. In this way, Secure Connector 303 can facilitate communication between Clearinghouse 200 and multiple different kinds of Operations Services 304, such as may be operated by different educational institutions (i.e., different instances of School 300). Conversely, Secure Connector 303 can encode responses (e.g., transcripts and other binary or text files) received from SIS 305 via Operations Services 304 as necessary for communication back to Clearinghouse 200 and, ultimately, Recipient 103.

In a preferred embodiment, Secure Connector 303 does not interface directly with SIS 305. Instead, all requests of and responses from SIS 305 are routed through Operations Services 304, which is configured and trusted by School 300. In this way, School 300 can ensure the security of SIS 305. SIS 305 can be any database suitable for storing educational information, including, for example, PeopleSoft Campus Solutions, which is already used by many educational institutions throughout the United States.

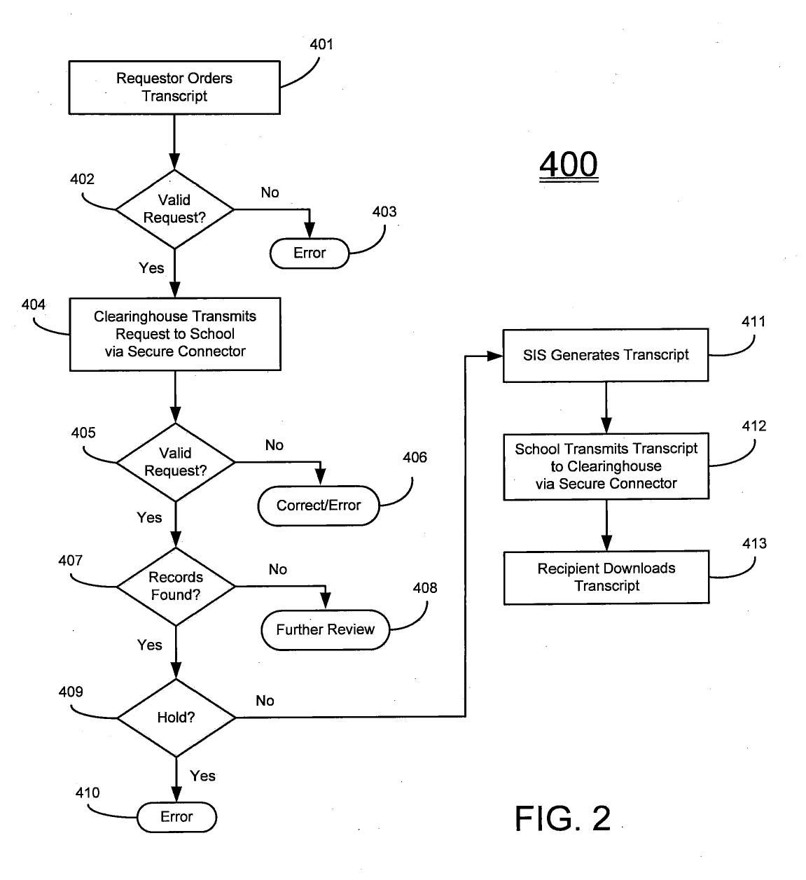

An exemplary Method 400 for securely providing education records via the Internet using the system depicted in FIG. 1 will now be described with reference to the flow chart provided in FIG. 2. At Step 401, Requestor 101 places an order for an electronic transcript via Application Services 202 provided by Clearinghouse 200. For example, Application Services 202 might include a web server module for hosting a web site where Requestor 101 can access, complete, and securely submit an order via Internet 102.

At Step 402, Application Services 202 validates the order received from Requestor 101. For example, Application Services 202 ensures that the order complies with the Family Educational Rights and Privacy Act (“FERPA”). If Requestor 101 requests that his transcript be sent to himself or to an educational institution in which he intends to enroll, then Application Services 202 prompts him to electronically sign a release during the ordering process. Alternatively, if the Requestor 101 requests that his transcript be sent to a prospective employer, then Application Services prompts Requestor 101 to print, sign, and return by facsimile an executed FERPA consent form. At Step 402, Application Services 202 can also validate the recipient address, payment details, or any other information associated with the order. If Application Services 202 determines that the order cannot be validated (e.g., because FERPA consent has not been obtained or credit card details cannot be confirmed), then Method 400 proceeds to Error 403, where Application Services 202 could, for example, return an appropriate error message to Requestor 101. Requestor 101 could then obtain the necessary FERPA consent and correct any other errors in the order and then try to submit it again.

If the order is successfully validated by the Clearinghouse at Step 402, then the Clearinghouse transmits the order to the relevant School 300 via Internet 102. Secure Connector 303 provides security and authentication for the transmission. In this way, the School 300 can be certain that the order details (e.g., the Social Security Number of the student whose records have been requested) are not intercepted by a third party and that the order is from Clearinghouse 200. Application Services 202 also provides a status update to Requestor 101 (e.g., by sending an e-mail message or posting a status update on a secure web site hosted by Application Services 202) to inform Requestor 101 that the order has been accepted and submitted to School 300 for fulfillment.

At Step 405, Secure Connector 303 validates the order to ensure it is in the expected format. If necessary, Secure Connector 303 can also reformat the order to comply with the interface specification of Operations Services 304. If Secure Connector is unable to validate the order or reformat it to comply with the Operations Services 304 interface specification, then Error 406 results. At Error 406, Integration Services 302 sends a message back to Clearinghouse 200 via Internet 102 indicating that an error occurred and providing any relevant details. Upon receipt of the error message, Application Services 202 again provides a status update to Requestor 101, as described above.

If Secure Connector 303 successfully validates the order at Step 405, then Secure Connector 303 forwards the order to Operations Services 304 at Step 407. Upon receipt, Operations Services 304 adds the order to a database of pending orders and also queries SIS 305 to determine whether the requested educational information exists. If the requested education information cannot be found (e.g., because the student's name is misspelled in the order), then Method 400 proceeds to Step 408, where the order can be flagged for further review (e.g., by staff in the Registrar's Office of School 300). At Step 408, Integration Services 302 also sends a status update to Clearinghouse 200, so Requestor 101 can be informed of the error.

If the requested educational records are found, then Method 400 proceeds to Step 409 where Integration Services 304 queries SIS 305 to determine whether the requested records are subject to a hold (e.g., a financial hold). If the records are subject to a hold, then Integration Services 304 proceeds to Error 410 and reports the error back to Clearinghouse 200 so the Requestor 101 can be notified, as described above. If the requested records are not subject to a hold, then Integration Services 304 requests that SIS 305 export the requested records at Step 411, so they can be securely transmitted back to Clearinghouse 200 via Secure Connector 303. In this example, SIS 305 together with Operations Services 304 creates an electronic transcript in Portable Document Format (“PDF”) format. Alternatively, SIS 305 could export the records as an XML file, or in any other suitable format. At Step 412, Secure Connector 303 then encodes and encrypts the transcript for secure transmission to Clearinghouse 200 via Internet 102. In one embodiment, Clearinghouse 200 certifies the transcript (e.g., by digitally signing the PDF). This way, Recipient 103 can be assured that the transcript is genuine and has not been altered (e.g., to show inflated grades).

Upon receipt of the requested educational records (e.g., the aforementioned PDF transcript), Clearinghouse 200 notifies Requestor 101 and Recipient 103 that the order is complete and provides instructions for downloading the records at Step 413. Clearinghouse 200 can, for example, direct the Recipient 103 to a web site hosted by Application Services 202, where Recipient 103 can log-in with a pre-defined username and password. Alternatively, Clearinghouse 200 could provide a unique Uniform Resource Locator (“URL”) link that Recipient 103 can follow to access the records. In other embodiments, Clearinghouse 200 could send the records to Requestor 101 via facsimile, postal mail, or e-mail, though the latter is not preferred since it provides less security than the other electronic delivery methods described above. After Recipient 103 downloads the records, or after some predetermined time, Clearinghouse 200 deletes the records from Application Services 202. Clearinghouse 200 also notifies Requestor 101 once Recipient 103 has downloaded the records.

The above description and drawings merely illustrate exemplary embodiments. Although certain advantages and exemplary embodiments have been described above, those skilled in the art will recognize that substitutions, additions, deletions, modifications and other changes may be made without departing from the spirit or scope of the invention. Accordingly, the invention is not limited by the foregoing description but is only limited by the scope of the following claims.

We claim:

1. A system for securely providing educational records via a computer network, the system comprising:
a clearinghouse server communicatively coupled to a computer network and configured to:
receive a request for an educational record from a requestor in communication with the clearinghouse server via the computer network;
transmit the request to a school server via the computer network;
receive a responsive educational record from the school server via the computer network; and
make the responsive educational record available for download by a recipient via the computer network,
wherein the school server comprises a secure connector module configured to:
facilitate secure communication of requests and responses between the school server and the clearinghouse server;
interface with a student information system server to retrieve an educational record responsive to the request; and
securely communicate the responsive educational record to the clearinghouse server.

2. The system of claim 1, wherein the clearinghouse server comprises a web server module configured to receive the request for an educational record from the requestor via the Internet.

3. The system of claim 1, wherein the responsive educational record is an academic transcript.

4. The system of claim 3, wherein the transcript is digitally signed before being made available to the recipient.

5. The system of claim 4, wherein the transcript is digitally signed by the educational institution or clearinghouse server.

6. The system of claim 1, wherein the secure connector module is further configured to encrypt communications between the clearinghouse server and the school server.

7. The system of claim 1, wherein the secure connector module is further configured to check a digital signature on the request to ensure that it is from the clearinghouse server.

8. The system of claim 1, wherein the secure connector module is further configured to reformat the request received from the clearinghouse server to interface with the student information system server.

9. The system of claim 1, wherein the secure connector module is further configured to interface with the student information system server through a operations services module configured by the educational institution.

10. A method for electronically requesting and transmitting educational transcripts, the method comprising:
receiving a request for a transcript at a clearinghouse server via the Internet;
securely transmitting the request from the clearinghouse server to an educational institution server via a network;
receiving at the clearinghouse server an electronic transcript responsive to the request from the educational institution server; and
hosting the transcript on the clearinghouse server such that the request or a recipient designated by the requestor can download the transcript via the network,
wherein the electronic transcript is retrieved from a student information system server operated by the educational institution.

11. The method of claim 10, wherein the step of securely transmitting the request to the educational institution server via the network comprises encrypting and digitally signing the request.

12. The method of claim 10, wherein the electronic transcript is in Portable Document Format and digitally signed by the educational institution server or the clearinghouse server.

13. The method of claim 10, further comprising providing a status update to the requestor when the electronic transcript is downloaded by the designated recipient.

14. The method of claim 10, further comprising providing a status update to the requestor if an electronic transcript responsive to the request cannot be found on the student information system server.

15. The method of claim 10, wherein the hosting step comprises sending a unique Uniform Resource Locator link to the requestor or the designated recipient.

16. The method of claim 10, wherein the hosting step comprises posting the electronic transcript on a secure web site accessible to the requestor or designated recipient.
